(19) United States
(12) Patent Application Publication
(10) Pub. No.: US 2025/0353635 A1
(43) Pub. Date: Nov. 20, 2025

(54) PRINTER DEVICE

(71) Applicant: TOSHIBA TEC KABUSHIKI KAISHA, Tokyo (JP)

(72) Inventor: Keigo Okasaka, Mishima Shizuoka (JP)

(21) Appl. No.: 19/068,028

(22) Filed: Mar. 3, 2025

(30) Foreign Application Priority Data
May 17, 2024 (JP) 2024-080609

(51) Int. Cl. B65C 9/00; B41J 3/407; B65C 1/02

(52) U.S. Cl. CPC B65C 9/0006; B41J 3/4075; B65C 1/025; B65C 2009/0009; B65C 2009/0096

(57) ABSTRACT

A printer device in which a backing paper from which a label is peeled off after printing can be easily set in a conveyance path provided at a bottom of the printer device when replacing a label paper. A label printer includes: a peeling roller and a peeling pinch roller that interpose and wind the backing paper after the label is peeled off; a peeling cover portion provided at the bottom of the printer device, holding the peeling pinch roller to be pressed against the peeling roller by supporting the peeling pinch roller and rotating the peeling cover portion around a rotation shaft perpendicular to a conveyance direction of the backing paper;

and a protruding portion and a magnet that holds the peeling cover portion at a label paper replacement position.

### CROSS-REFERENCE TO RELATED APPLICATION

This application is based upon and claims the benefit of priority from Japanese Patent Application No. 2024-080609, filed on May 17, 2024, the entire contents of which are incorporated herein by reference.

### FIELD

Embodiments described herein relate generally to a printer device, a method for a printer, and a label printer.

### BACKGROUND

A printer device that performs printing on a label attached to a backing paper of a label paper has been put to practical use. In such a printer device, an operator who replaces the label paper opens a housing of the printer device and loads new label paper from above the printer device.

When such a printer device is used in a shipping line of a factory or the like to attach printed labels to packaged products conveyed through a bottom of the printer device, since the backing paper after peeling off the label is positioned in the bottom of the printer device, it is difficult to insert an operator's hand into the bottom of the printer device to set a leading edge of the backing paper in a conveyance path when the label paper is replaced from above by opening the housing of the printer device.

### DESCRIPTION OF THE DRAWINGS

FIG. 1 is a diagram showing an example of a schematic configuration of a label printer according to an embodiment;

FIG. 2 is a diagram showing an example of main components of a conveyance unit by which the label printer conveys a label paper;

FIG. 3 is a diagram showing an example of main components of a backing paper conveyance unit including a peeling roller and a peeling pinch roller that convey backing paper after label peeling;

FIG. 4 is an external perspective view showing an example of a peeling cover portion;

FIG. 5 is a diagram showing an example of a state in which the peeling cover portion is positioned in a label paper replacement position in the label printer; and

FIG. 6 is a diagram showing a process of setting the backing paper when replacing the label paper in the label printer.

### DETAILED DESCRIPTION

The invention provides a printer device in which a backing paper from which label is peeled off after printing can be easily set in a conveyance path provided at a bottom of the printer device when replacing a label paper.

In general, according to one embodiment, a printer device applies a printed label peeled off from a backing paper of a label paper to an attachment target object conveyed along a bottom surface of the printer device, the device including: a peeling roller and a peeling pinch roller that interpose and wind the backing paper from which the label is peeled off; a peeling cover portion provided at a bottom of the printer device, holding the peeling pinch roller to be pressed against the peeling roller by supporting the peeling pinch roller and rotating the peeling cover portion around a rotation shaft perpendicular to a conveyance direction of the backing paper; and a holding unit that holds the peeling cover portion at a paper replacement position where replacement backing paper is inserted between the peeling roller and the peeling pinch roller when replacing the label paper by rotating the peeling cover portion around the rotation shaft, releasing pressure contact between the peeling roller and the peeling pinch roller, and aligning the rotated peeling cover portion along a guide surface on a side opposite to a side where the peeling cover portion supports the peeling pinch roller.

### Embodiment

Hereinafter, a label printer 10 according to an embodiment of the invention will be described with reference to the accompanying drawings.

### (Overall Configuration of Label Printer)

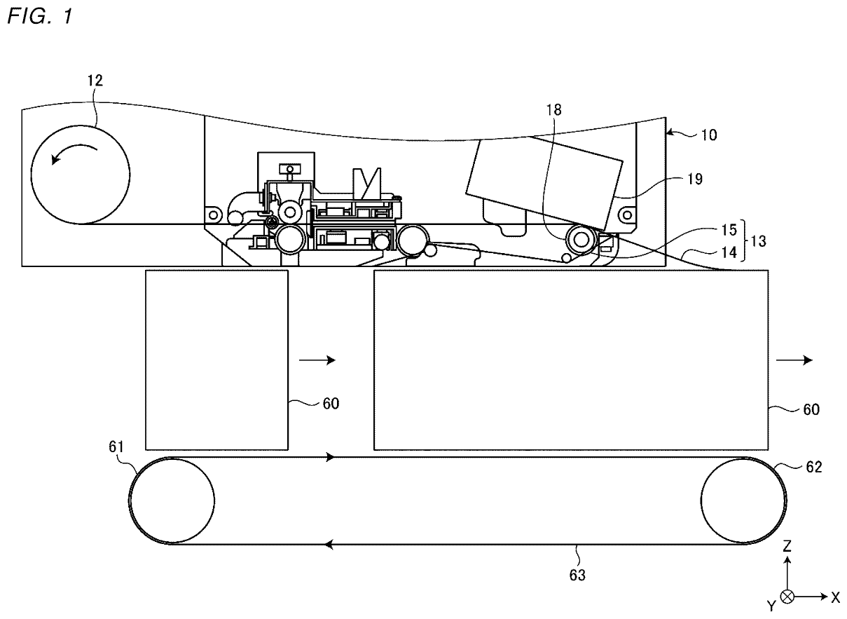

A schematic configuration of the label printer 10 according to the embodiment will be described with reference to FIG. 1. FIG. 1 is a diagram showing an example of the schematic configuration of the label printer according to the embodiment. Note that the label printer 10 is an example of a printer device in the present disclosure.

The label printer 10 performs printing on a label 14 attached to a backing paper 15 of a label paper 13 while pulling out the label paper 13 from a label roll 12 wound in a roll shape. A rear surface side of the label 14 is an adhesive layer, and the label 14 is attached to be peelable to the backing paper 15 by the adhesive layer.

The label paper 13 is pulled out from the label roll 12 while being interposed between a platen roller 18 driven rotationally by a driving motor such as a stepping motor (not shown) and a printing unit 19, and is conveyed along an X-axis shown in FIG. 1.

A thermal head (not shown) in the printing unit 19 prints a code symbol such as a bar code and a two-dimensional code, information indicating an address of a delivery destination, and the like on the label 14 attached to the backing paper 15 of the label paper 13. That is, the backing paper 15 is positioned on the platen roller 18 side and the label 14 is positioned on the printing unit 19 (thermal head) side.

After printing is completed, the label 14 is peeled off from the label paper 13 and attached to a packaged product 60 conveyed along a bottom surface of the label printer 10. The packaged product 60 is conveyed along the X-axis by a belt 63 supported by a pair of conveyance rollers 61 and 62.

### (Label Conveyance Mechanism of Label Printer)

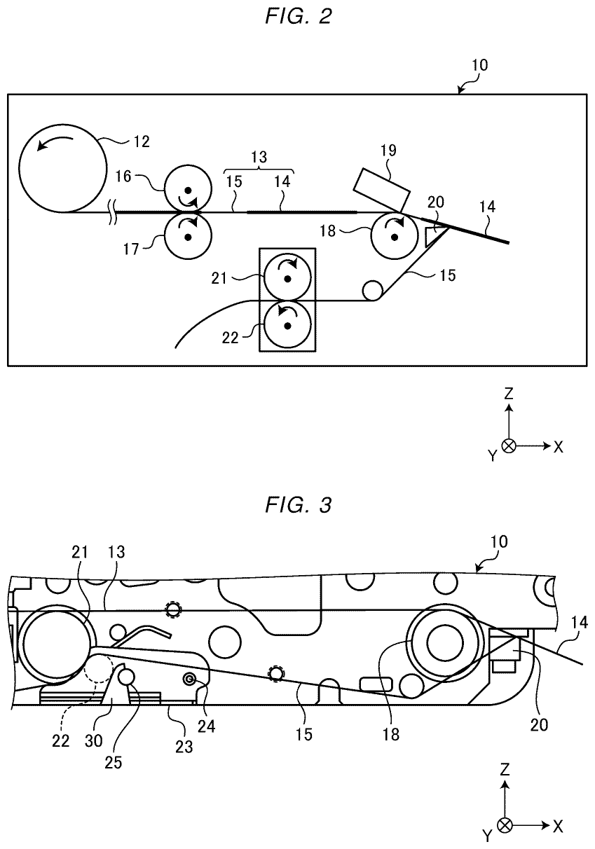

A conveyance mechanism by which the label printer 10 conveys the label paper 13 is described with reference to FIG. 2. FIG. 2 is a diagram showing an example of main components of a conveyance unit by which the label printer conveys the label paper.

The label paper 13 pulled out from the label roll 12 is interposed between a capstan roller 17 and a capstan pinch roller 16 in contact with each other. The capstan roller 17 is driven rotationally by a driving motor such as a stepping motor (not shown) to rotate clockwise in FIG. 2, thereby conveying the label paper 13 interposed between the capstan roller 17 and the capstan pinch roller 16 to a positive side of the X-axis.

Next, the label paper 13 is conveyed while being interposed between the platen roller 18 driven rotationally to rotate clockwise in FIG. 2 and the printing unit 19. Then, the thermal head (not shown) of the printing unit 19 prints various types of information on the label 14.

The thermal head has a structure in which a plurality of heating elements are arranged, and performs printing on the label 14, that is a heat-sensitive paper, interposed between the thermal head and the platen roller 18 by heating the heating elements corresponding to the printing pattern. The label printer 10 may be a type that performs printing by interposing an ink ribbon (not shown) between the thermal head and the label 14 and transferring ink of the ink ribbon heated by the thermal head to the label 14.

The label printer 10 is equipped with a label detection mechanism (not shown) that detects a position of the label 14 to perform printing accurately at the position of the label 14. Any type of the label detection mechanism can be used, and for example, a label detection mechanism that detects the printing start position by attaching a marker that specifies a printing start position to the label paper 13 and detecting the position of the marker by an optical sensor such as a photo interrupter equipped in the label printer 10 may be used.

The printed label 14 is peeled off from the backing paper 15 by a peeling guide 20. Next, the label 14 is attached to the packaged product 60 shown in FIG. 1.

The peeling guide 20 is formed in a V-shape with two surfaces that intersect with each other at an acute angle. The peeling guide 20 bends the conveyed label paper 13 to peel off the label 14 from the backing paper 15.

After passing through the peeling guide 20, the backing paper 15 from which the label 14 is peeled off changes orientation to a negative side of the X-axis and is interposed between a peeling roller 21 and a peeling pinch roller 22. The peeling roller 21 is driven rotationally by a driving motor such as a stepping motor (not shown) to rotate clockwise in FIG. 2. That is, the peeling roller 21 is a driving roller and the peeling pinch roller 22 is a driven roller.

The backing paper 15 is conveyed to the negative side of the X-axis while being interposed between the peeling roller 21 and the peeling pinch roller 22. The backing paper 15 that passed between the peeling roller 21 and the peeling pinch roller 22 may be wound around a winding shaft (not shown).

### (Main Components of Backing Paper Conveyance Unit)

Main components of the backing paper conveyance unit including the peeling roller 21 and the peeling pinch roller 22 are described with reference to FIG. 3. FIG. 3 is a diagram showing an example of the main components of the backing paper conveyance unit including the peeling roller and the peeling pinch roller that convey the backing paper after label peeling.

The peeling pinch roller 22 is pressed against the peeling roller 21 while being supported by the peeling cover portion 23. The backing paper 15 is conveyed downstream (negative side of the X-axis in FIG. 3) while being interposed between the peeling roller 21 and the peeling pinch roller 22.

The peeling cover portion 23 is provided in the bottom of the label printer 10 to be rotatable around a rotation shaft 24 along a Y-axis. When replacing the label paper 13, an operator opens the peeling cover portion 23 and sets the backing paper 15 in a conveyance path.

A protruding portion 25 along the Y-axis is formed on a side surface of the peeling cover portion 23. The protruding portion 25 is made of a material that adheres to a magnet. When the peeling cover portion 23 is closed, the protruding portion 25 is engaged with a stopper 30 provided in the label printer 10. When the peeling cover portion 23 is closed, the stopper 30 is pressed and bent by the protruding portion 25, and engages with the protruding portion 25 while the peeling pinch roller 22 is pressed against the peeling roller 21. The protruding portion 25 is an example of an engaging member in the disclosure.

Note that a structure of the stopper 30 is not limited thereto. For example, the stopper 30 may be provided to be biased by an elastic member such as a spring toward the positive side of the X-axis, so that when the peeling cover portion 23 is closed, a pressing force of the protruding portion 25 overcomes the bias and the stopper 30 engages with the protruding portion 25.

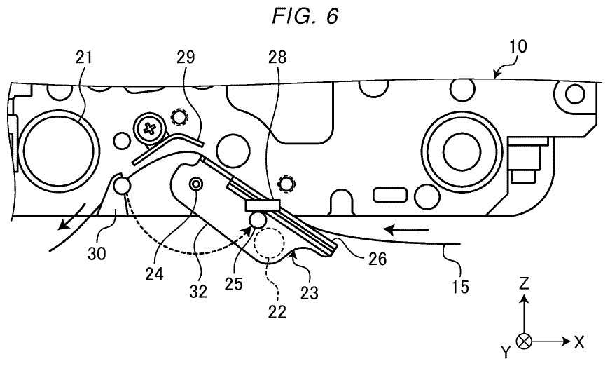

The operator replacing the label paper 13 opens an opening (not shown) on a top surface or a side surface of the label printer 10 and inserts a new label roll 12. Next, a leading edge of the label paper 13 is inserted between the platen roller 18 and the printing unit 19 and is supported by the peeling guide 20. Then, the peeling cover portion 23 is opened to the bottom surface side of the label printer 10, and the leading edge of the label paper 13 (backing paper 15) is inserted between the peeling roller 21 and the peeling pinch roller 22. An action of the peeling cover portion 23 when replacing the label paper 13 is described in detail below (refer to FIG. 6).

### (Structure of Peeling Cover Unit)

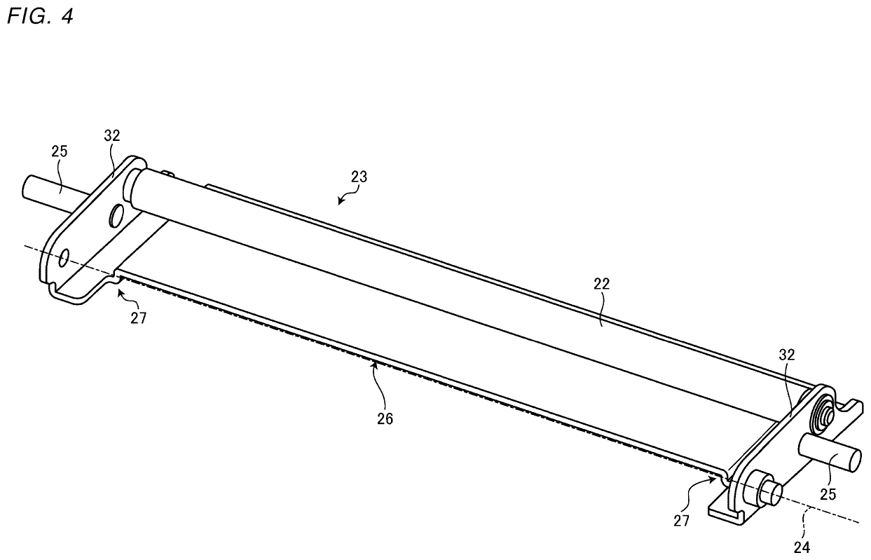

A detailed structure of the peeling cover portion 23 will be described with reference to FIG. 4. FIG. 4 is an external perspective view showing an example of the peeling cover portion.

As shown in FIG. 4, the peeling cover portion 23 includes a pair of convex portions 27 on both ends of a planar backing paper guide surface 26. The pair of convex portions 27 are formed to protrude from the backing paper guide surface 26 along the conveyance direction of the backing paper 15. The distance between the pair of convex portions 27 is larger than a width of the backing paper 15. The backing paper guide surface 26 is an example of a guide surface in the disclosure.

The peeling cover portion 23 supports the peeling pinch roller 22 at both ends, on a side opposite to a protruding direction of the convex portion 27, that is, on a rear surface side of the backing paper guide surface 26. More specifically, the peeling pinch roller 22 is rotatably supported at both ends by wall portions 32 formed at both ends of the peeling cover portion 23.

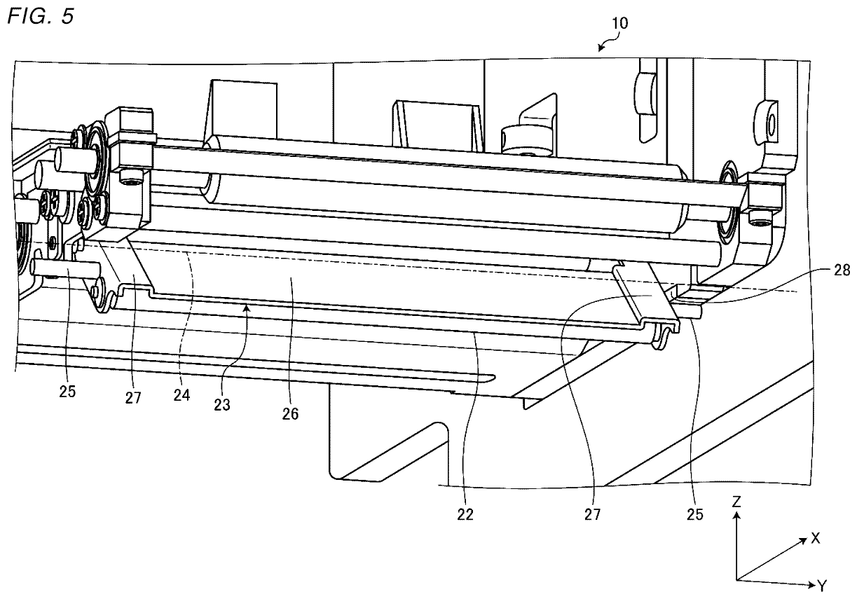

The wall portions 32 formed at both ends of the peeling cover portion 23 are provided with columnar protruding portions 25 that protrude outward from the peeling cover portion 23 along the rotation shaft 24. The protruding portions 25 are formed of a material such as iron that adheres to a magnet 28 (refer to FIGS. 5 and 6) when the peeling cover portion 23 is opened.

### (Method of Setting Backing Paper When Replacing Label Paper)

A method for setting the backing paper 15 when replacing the label paper 13 in the label printer 10 will be described with reference to FIGS. 5 and 6. FIG. 5 is a diagram showing an example of a state in which the peeling cover portion is positioned at the label paper replacement position in the label printer. FIG. 6 is a diagram showing a process of setting the backing paper when replacing the label paper in the label printer.

FIG. 5 shows an example of a state in which the peeling cover portion 23 is opened and the opened peeling cover portion 23 is fixed at the label paper replacement position when replacing the label paper 13.

By pulling the peeling cover portion 23 toward the bottom side of the label printer 10, that is, toward a negative side of a Z-axis, the engagement between the protruding portion 25 and the stopper 30 described above is released. Then, the peeling cover portion 23 rotates around the rotation shaft 24 so that the peeling roller 21 and the peeling pinch roller 22 are separated.

When the peeling cover portion 23 is rotated, the protruding portion 25 provided on the peeling cover portion 23 adheres to the magnet 28 provided in the label printer 10. As a result, the peeling cover portion 23 is fixed at the label paper replacement position. Note that the protruding portion 25 and the magnet 28 configure a holding unit in the disclosure. In the label paper replacement position, as shown in FIG. 5, the backing paper guide surface 26 is held upward, that is, on a positive side of the Z-axis. The operator inserts the leading edge of the backing paper 15 along the backing paper guide surface 26. Here, since a pair of convex portions 27 are formed on both ends of the backing paper guide surface 26, the inserted backing paper 15 is easily guided along the pair of convex portions 27 inward from the backing paper guide surface 26.

Note that in FIG. 5, the magnet 28 is provided only on one side of the peeling cover portion 23, that is, on a positive side of the Y-axis, but the magnet 28 may be provided on both sides of the peeling cover portion 23 so that the protruding portions 25 adhere at two portions.

FIG. 6 shows a process in which the operator sets the leading edge of the backing paper 15 when the peeling cover portion 23 is held at the label paper replacement position.

When replacing the label paper 13, the operator opens the peeling cover portion 23 and rotates the peeling cover portion 23 around the rotation shaft 24 counterclockwise in FIG. 6, that is, in a direction of a dotted arrow in FIG. 6. Then, the operator holds the peeling cover portion 23 at a position where the protruding portion 25 adheres to the magnet 28.

Here, the backing paper guide surface 26 of the peeling cover portion 23 is held so that a position closer to the side from which the backing paper 15 is inserted protrudes more outward from the bottom of the label printer 10. Accordingly, the operator can find the position of the backing paper guide surface 26 by hands without looking at an insertion opening for the backing paper 15. Here, the operator inserts the backing paper 15 along the backing paper guide surface 26 in the direction of an arrow shown in FIG. 6.

Here, since the pair of convex portions 27 described above (refer to FIG. 5) are formed on both ends of the backing paper guide surface 26 in a width direction, the inserted backing paper 15 is guided along the pair of convex portions 27 toward the peeling roller 21 positioned inward from the backing paper guide surface 26.

The label printer 10 also includes a paper guide 29 inward from the backing paper guide surface 26. The paper guide 29 has an arc shape that guides the leading edge of the backing paper 15 inserted along the backing paper guide surface 26 toward a lower side of the peeling roller 21 (the negative side of the Z-axis). The backing paper 15 inserted at the label paper replacement position is guided by the paper guide 29 to pass between the peeling roller 21 and the peeling pinch roller 22. The paper guide 29 is an example of a guiding member in the disclosure.

The operator replacing the label paper 13 confirms that the leading edge of the inserted backing paper 15 sticks out from the bottom of the label printer 10 as shown in FIG. 6, and then applies force to the peeling cover portion 23 in a direction that releases the adhesion between the magnet 28 and the protruding portion 25, so that the hold of the peeling cover portion 23 at the label paper replacement position is released.

Next, the operator rotates the peeling cover portion 23 clockwise in FIG. 6 to engage the protruding portion 25 with the stopper 30. Here, the backing paper 15 is interposed between the peeling roller 21 and the peeling pinch roller 22, so that the setting of the backing paper 15 executed along with the replacement of the label paper 13 is completed.

### (Effects of Embodiment)

As described above, the label printer 10 of the embodiment (printer device) is a printer device that applies the printed label 14 peeled off from the backing paper 15 of the label paper 13 to an attachment target object conveyed along the bottom surface of the printer device, the device including: the peeling roller 21 and the peeling pinch roller 22 that interpose and wind the backing paper 15 from which the label 14 is peeled off; the peeling cover portion 23 provided at the bottom of the label printer 10, holding the peeling pinch roller 22 to be pressed against the peeling roller 21 by supporting the peeling pinch roller 22 and rotating the peeling cover portion 23 around the rotation shaft 24 perpendicular to the conveyance direction of the backing paper 15; and the protruding portion 25 and the magnet 28 (holding unit) that hold the peeling cover portion 23 at the label paper replacement position where a replacement backing paper 15 is inserted between the peeling roller 21 and the peeling pinch roller 22 when replacing the label paper 13 by rotating the peeling cover portion 23 around the rotation shaft 24, releasing pressure contact between the peeling pinch roller 22 and the peeling roller 21, and aligning the rotated peeling cover portion 23 along the surface on the side opposite to the side where the peeling cover portion 23 supports the peeling pinch roller 22. Therefore, when replacing the label paper 13, the backing paper 15 from which the label 14 is peeled off after printing can be easily set in the conveyance path provided at the bottom of the label printer 10.

In the label printer 10 of the embodiment, the holding unit includes the protruding portion 25 that protrudes from the peeling cover portion 23 in the direction along the rotation shaft 24 and the magnet 28 that is provided on the housing of the label printer 10 (printer device) and adheres to the protruding portion 25 when the peeling cover portion 23 is rotated to the label paper replacement position. Therefore, with a simple configuration, the peeling cover portion 23 that also serves as a guide for setting the backing paper 15 in the conveyance path can be held in the label paper replacement position.

In the label printer 10 of the embodiment, the protruding portion 25 also serves as an engaging member that engages the peeling cover portion 23 when holding the peeling cover portion 23 while the peeling pinch roller 22 and the peeling roller 21 are pressed against each other. Therefore, the protruding portion 25 can be used both as a holding unit for holding the peeling cover portion 23 in the label paper replacement position and as an engagement unit for engaging with the peeling cover portion 23 when the peeling cover portion 23 is closed.

In the label printer 10 of the embodiment, at the label paper replacement position, the backing paper guide surface 26 (guide surface) is held so that a position closer to the side from which the backing paper 15 is inserted protrudes more outward from the bottom of the label printer 10. Therefore, since the operator replacing the label paper 13 can insert the leading edge of the backing paper 15, for example, by hands without looking at the insertion opening for the backing paper 15, operability when replacing the label paper 13 can be improved.

In the label printer 10 of the embodiment, the peeling cover portion 23 includes a pair of convex portions 27 that are provided on the surface opposite to the side supporting the peeling pinch roller 22, have a width larger than a width of the backing paper 15 in a direction perpendicular to the peeling pinch roller 22, and guide the backing paper 15. Therefore, when inserting the backing paper 15 into the backing paper guide surface 26 at the label paper replacement position, the insertion direction of the backing paper 15 is guided, so that operability of inserting the backing paper 15 into the backing paper guide surface 26 can be improved even at the bottom of the label printer 10 that may be difficult to look at depending on circumstances.

The label printer 10 of the embodiment further includes the paper guide 29 (guiding member) that guides the backing paper 15 inserted at the label paper replacement position so that the backing paper 15 passes between the peeling roller 21 and the peeling pinch roller 22. Therefore, operability of setting the backing paper 15 in the conveyance path can be further improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer device that applies a printed label peeled off from a backing paper of a label paper to an attachment target object conveyed along a bottom surface of the printer device, the printer device comprising:
a peeling roller and a peeling pinch roller that interpose and wind the backing paper from which the printed label is peeled off;
a peeling cover portion provided at a bottom of the printer device, holding the peeling pinch roller to be pressed against the peeling roller by supporting the peeling pinch roller and rotating the peeling cover portion around a rotation shaft perpendicular to a conveyance direction of the backing paper; and
a holding component that holds the peeling cover portion at a label paper replacement position where a replacement backing paper is inserted between the peeling roller and the peeling pinch roller when replacing the label paper by rotating the peeling cover portion around the rotation shaft, releasing pressure contact between the peeling roller and the peeling pinch roller, and aligning the rotated peeling cover portion along a guide surface on a side opposite to a side where the peeling cover portion supports the peeling pinch roller.

2. The printer device according to claim 1, wherein the holding component includes
a protruding portion that protrudes from the peeling cover portion in a direction along the rotation shaft, and
a magnet provided on a housing of the printer device and adhering to the protruding portion when the peeling cover portion is rotated to the label paper replacement position.

3. The printer device according to claim 2, wherein the protruding portion serves as an engaging member that engages with the peeling cover portion when holding the peeling cover portion while the peeling pinch roller and the peeling roller are pressed against each other.

4. The printer device according to claim 1, wherein the guide surface is held at the label paper replacement position so that a position closer to a side from which the backing paper is inserted protrudes farther outward from the bottom of the printer device.

5. The printer device according to claim 1, wherein the peeling cover portion includes a pair of protruding portions that are provided on a surface opposite to a side supporting the peeling pinch roller, the pair of protruding portions have a width larger than a width of the backing paper in a direction perpendicular to the peeling pinch roller, and guide the backing paper.

6. The printer device according to claim 1, further comprising a guiding component that guides the backing paper inserted at the label paper replacement position so that the backing paper passes between the peeling roller and the peeling pinch roller.

7. The printer device according to claim 1, wherein the peeling cover portion includes a pair of convex portions on both ends of the guide surface, the pair of convex portions protrude from the guide surface along the conveyance direction of the backing paper, a distance between the pair of convex portions is larger than a width of the backing paper.

8. A label printer that applies a printed label peeled off from a backing paper of a label paper to an attachment target object conveyed along a bottom surface of the label printer, the label printer comprising:
a peeling roller and a peeling pinch roller that interpose and wind the backing paper from which the printed label is peeled off;
a peeling cover portion provided at a bottom of the label printer, holding the peeling pinch roller to be pressed against the peeling roller by supporting the peeling pinch roller and rotating the peeling cover portion around a rotation shaft perpendicular to a conveyance direction of the backing paper; and
a holding component that holds the peeling cover portion at a label paper replacement position where a replacement backing paper is inserted between the peeling roller and the peeling pinch roller when replacing the label paper by rotating the peeling cover portion around the rotation shaft, releasing pressure contact between the peeling roller and the peeling pinch roller, and aligning the rotated peeling cover portion along a guide surface on a side opposite to a side where the peeling cover portion supports the peeling pinch roller.

9. The label printer according to claim 8, further comprising a label detection mechanism that detects a position of a label prior to printing the label.

10. The label printer according to claim 8, wherein the holding component includes
a protruding portion that protrudes from the peeling cover portion in a direction along the rotation shaft, and
a magnet provided on a housing of the printer device and adhering to the protruding portion when the peeling cover portion is rotated to the label paper replacement position.

11. The label printer according to claim 10, wherein the protruding portion serves as an engaging member that engages with the peeling cover portion when holding the peeling cover portion while the peeling pinch roller and the peeling roller are pressed against each other.

12. The label printer according to claim 8, wherein the guide surface is held at the label paper replacement position so that a position closer to a side from which the backing paper is inserted protrudes farther outward from the bottom of the label printer.

13. The label printer according to claim 8, wherein the peeling cover portion includes a pair of protruding portions that are provided on a surface opposite to a side supporting the peeling pinch roller, the pair of protruding portions have a width larger than a width of the backing paper in a direction perpendicular to the peeling pinch roller, and guide the backing paper.

14. The label printer according to claim 8, further comprising a guiding component that guides the backing paper inserted at the label paper replacement position so that the backing paper passes between the peeling roller and the peeling pinch roller.

15. The label printer according to claim 8, wherein the peeling cover portion includes a pair of convex portions on both ends of the guide surface, the pair of convex portions protrude from the guide surface along the conveyance direction of the backing paper, a distance between the pair of convex portions is larger than a width of the backing paper.

16. A method for a printer, comprising:
applying a printed label peeled off from a backing paper of a label paper to an attachment target object conveyed along a bottom surface of the printer;
interposing and winding a peeling roller and a peeling pinch roller to peel off the printed label from the backing paper;
holding the peeling pinch roller to be pressed against the peeling roller by supporting the peeling pinch roller and rotating a peeling cover portion around a rotation shaft perpendicular to a conveyance direction of the backing paper the peeling cover portion provided at a bottom of the printer; and
holding the peeling cover portion at a label paper replacement position where a replacement backing paper is inserted between the peeling roller and the peeling pinch roller when replacing the label paper by rotating the peeling cover portion around the rotation shaft, releasing pressure contact between the peeling roller and the peeling pinch roller, and aligning the rotated peeling cover portion along a guide surface on a side opposite to a side where the peeling cover portion supports the peeling pinch roller.

17. The method according to claim 16, further comprising:
engaging with the peeling cover portion when holding the peeling cover portion while the peeling pinch roller and the peeling roller are pressed against each other.

18. The method according to claim 16, further comprising:
holding the guide surface at the label paper replacement position so that a position closer to a side from which the backing paper is inserted protrudes farther outward from the bottom of the printer device.

19. The method according to claim 16, further comprising:
guiding the backing paper with the peeling cover portion that includes a pair of protruding portions that are provided on a surface opposite to a side supporting the peeling pinch roller, the pair of protruding portions have a width larger than a width of the backing paper in a direction perpendicular to the peeling pinch roller.

20. The method according to claim 16, further comprising:
guiding the backing paper inserted at the label paper replacement position so that the backing paper passes between the peeling roller and the peeling pinch roller.
